(19) United States
(12) Patent Application Publication
(10) Pub. No.: US 2022/0046365 A1
(43) Pub. Date: Feb. 10, 2022

(54) METHOD FOR OPERATING A HEARING AID AND HEARING AID

(71) Applicant: SIVANTOS PTE. LTD., SINGAPORE (SG)

(72) Inventor: SEBASTIAN BEST, ERLANGEN (DE)

(21) Appl. No.: 17/444,491

(22) Filed: Aug. 5, 2021

(30) Foreign Application Priority Data
Aug. 5, 2020 (DE) 10 2020 209 907.3

(51) Int. Cl. H04R 25/00; G10L 25/84

(52) U.S. Cl. CPC H04R 25/505; H04R 2460/01; G10L 25/84

(57) ABSTRACT

A method for operating a hearing aid includes providing the hearing aid with an ANC unit and a speech recognition unit. The ANC unit is configured to process multiple frequency ranges and at the same time to suppress noises from the surroundings in each of these frequency ranges using a respectively settable ANC strength. The speech recognition unit recognizes for each of the frequency ranges whether or not speech is present therein. The ANC unit is controlled in such a way that the ANC strength is set for a respective frequency range depending on whether or not the speech recognition unit has recognized speech in that frequency range. A hearing aid having a control unit configured to execute the method is also provided.

### CROSS-REFERENCE TO RELATED APPLICATION

This application claims the priority, under 35 U.S.C. § 119, of German Patent Application DE 10 2020 209 907.3, filed Aug. 5, 2020; the prior application is herewith incorporated by reference in its entirety.

### BACKGROUND OF THE INVENTION

### Field of the Invention

The invention relates to a method for operating a hearing aid and to a corresponding hearing aid.

A hearing aid is used to output noises to a user of the hearing aid. The user wears the hearing aid for that purpose on or in the ear. In order to output noises, the hearing aid has a receiver and at least one microphone to record noises from the surroundings and then output them to the user. The noises are additionally modified in that case by the hearing aid to compensate for a hearing loss of the user. The hearing aid is therefore also referred to as a hearing aid device.

A hearing aid can additionally carry out active noise suppression, which is also referred to as “active noise cancellation,” and is abbreviated as ANC. Through the use of ANC, noises from the surroundings are suppressed, especially interference noises, so that a calmed hearing situation results for the user. In the case of ANC, noises which reach the auditory canal of the user from the surroundings from the outside are typically suppressed. The concept of ANC is also applicable to noise in the auditory canal, which is then referred to as “active occlusion reduction,” and is abbreviated as AOR. In contrast to the above-mentioned suppression of interference noises from the outside, by using AOR, in particular those noises are also suppressed which arise due to the user himself or herself or which result from standing waves in the auditory canal. That is especially the case if the auditory canal is closed in relation to the surroundings by an earpiece. AOR is accordingly predominantly an internal noise suppression, which suppresses interference noises in the auditory canal, while in contrast ANC typically means an external noise suppression, which suppresses interference noises from outside the auditory canal. The actual noise suppression takes place in both cases inside the auditory canal by generating an inverted signal, which is acoustically superimposed with the interference noise in the auditory canal and then at least partially extinguishes the interference noise. Overall, in both cases interference noises, i.e., those noises which are typically perceived as annoying by the user, are suppressed and thus a calmed hearing situation is produced.

Active noise suppression in the context of a hearing aid is described, for example, in European Patent EP 1 690 252 B1, corresponding to U.S. Pat. No. 7,590,254; European Patent EP 2 023 664 B1, corresponding to U.S. Pat. No. 8,229,127; German Patent Application DE 10 2008 015 264 A1, corresponding to U.S. Pat. No. 8,553,917; German Patent DE 10 2009 010 892 B4, corresponding to U.S. Patent Application Publication No. 2010/0220881; European Patent EP 2 309 778 B1, corresponding to U.S. Patent Application Publication No. 2011/0069852; and European Patent EP 2 405 674 B1, corresponding to U.S. Pat. No. 9,794,700.

It is problematic in the use of ANC that under certain circumstances useful noises are also suppressed, especially speech. Speech is generally a noise from the surroundings and is accordingly regularly suppressed by ANC. Especially external speech, which does not originate from the user of the hearing aid himself or herself, but rather from another person, often represents a useful noise, however, which is to be output again as comprehensibly as possible to the user. That is relevant in particular in a conversation situation, in which the user of a hearing aid converses with one or only a few other persons. However, cases are also conceivable in which speech is considered to be an interference noise and is to be suppressed, for example, in a so-called cocktail party situation, in which the speech of a plurality of speakers, with whom the user is not conversing as such, forms a background noise. However, it is desirable in principle to output speech as comprehensibly as possible. At the same time, however, the calmest possible hearing situation for the user is to be produced by using ANC. A conflict of goals thus exists between the suppression of noises and the output of speech.

### BRIEF SUMMARY OF THE INVENTION

It is accordingly an object of the invention to provide an improved method for operating a hearing aid and a hearing aid suitable for carrying out the method, which overcome the hereinafore-mentioned disadvantages of the heretofore-known methods and hearing aids of this general type. In the method, in particular the output of speech to a user of the hearing aid is to be improved.

With the foregoing and other objects in view there is provided, in accordance with the invention, a method for operating a hearing aid, wherein:
a) the hearing aid has an ANC unit and a speech recognition unit,
b) the ANC unit is configured to process multiple frequency ranges and at the same time to suppress noises from the surroundings in each of these frequency ranges using a respectively settable ANC strength,
c) the speech recognition unit recognizes for each of the frequency ranges whether or not speech is present therein, and
d) the ANC unit is controlled in such a way that the ANC strength is set for a respective frequency range depending on whether or not the speech recognition unit has recognized speech in this frequency range.

Advantageous embodiments, refinements, and variants are the subject matter of the dependent claims. The statements in conjunction with the method also apply accordingly to the hearing aid and vice versa. Insofar as method steps of the method are described hereinafter, advantageous embodiments for the hearing aid result in particular in that it is configured to execute one or more of these method steps.

The method is used for operating a hearing aid, in particular during the intended use of the hearing aid, i.e., while the hearing aid is worn by a user for use. The hearing aid is generally used to output noises to the user of the hearing aid and especially preferably to compensate for a hearing deficit of a hearing-impaired user in particular. In particular, the hearing aid has at least one microphone, which records the noises from the surroundings. The noises from the surroundings are also referred to as ambient noises or as ambient sound. The microphone is suitably a so-called external microphone, thus it faces outward with respect to the auditory canal and in particular not into it. The microphone converts the noises into an input signal, which is an electrical signal. The input signal is processed by a control unit of the hearing aid as needed and finally supplied to a receiver of the hearing aid. The receiver converts the input signal into sound for output to the user.

The hearing aid has an ANC unit, wherein ANC is understood to mean active noise suppression, also referred to as “active noise cancellation.” The ANC unit is in particular a part of the control unit. The ANC unit is configured to process multiple frequency ranges and in this case to suppress noises from the surroundings in each of these frequency ranges with a settable ANC strength in each case. The ANC strength is individually settable for each frequency range. The noises from the surroundings regularly include, depending on the surrounding situation, interference noises or useful noises or even both and regularly in particular speech, which is typically a useful noise. The input signal is supplied to the ANC unit. This is understood to mean that the input signal is entirely or partially supplied to the ANC unit, wherein at least those frequency ranges which are to be processed by the ANC unit are supplied. The ANC unit analyzes the input signal and outputs a feedforward signal as a result thereof, for suppressing the noises from the surroundings. In particular, those noises are suppressed which penetrate from the outside into an auditory canal of the user of the hearing aid during intended use, in particular past an earpiece of the hearing aid. The feedforward signal is generally also referred to as a correction signal. The correction signal is in particular an electrical signal which is then supplied to the receiver of the hearing aid and converted by the receiver into sound. This sound is then so-called anti-sound, which entirely or partially extinguishes, i.e., suppresses, the noises upon superposition in the auditory canal. Actual noise suppression takes place solely acoustically in this case and in particular not on an electrical level.

The ANC strength specifies how strongly noises are suppressed in the respective frequency range. For example, the ANC strength corresponds to an amplitude of the feedback signal or an amplification factor, using which the feedback signal is scaled in the ANC unit. The ANC strength is accordingly a measure of the suppression of noises in the respective frequency range. The greater the ANC strength is, the stronger is the suppression. Vice versa, at low ANC strength, only minor suppression takes place. Complete deactivation of the ANC unit for one or more frequency ranges is also possible, so that in these ranges no suppression of noises then takes place, the ANC strength is then more or less “0.” In contrast, a negative ANC strength, more or less to amplify noises, is in particular not provided.

Furthermore, the hearing aid has a speech recognition unit for recognizing speech. The speech recognition unit is in particular a part of the control unit. The speech recognition unit recognizes for each of the frequency ranges whether or not speech is present therein. For this purpose, the input signal is expediently supplied to the speech recognition unit. This is also understood to mean in this case that the input signal is entirely or partially supplied to the speech recognition unit. Alternatively or additionally, another input signal, which is generated, for example, by another, second microphone, in particular also an external microphone, is supplied to the speech recognition unit. Speech differs from other noises in particular due to certain chronological, spatial, or spectral features, on the basis of which the speech recognition unit then recognizes speech, for example, in the input signal.

Solely by way of example, in one variant for speech recognition, a spatial filter is used so that a signal is generated which only generates noises from a certain direction, from which speech is predominantly to be expected, and is supplied to the speech recognition unit. The presence of speech is then recognized by the speech recognition unit, for example, on the basis of the amplitude of this signal.

The speech recognition unit in particular analyzes each of the frequency ranges separately in the present case, so that it is determined for each of the frequency ranges independently of the other frequency ranges whether or not speech is present therein. The speech recognition unit expediently outputs a signal which specifies for each of the frequency ranges whether or not speech is present therein.

One core aspect in the present case is that the ANC unit is controlled in such a way that the ANC strength is set for a respective frequency range in dependence on whether or not the speech recognition unit has recognized speech in this frequency range. In other words: the ANC unit is controlled in a frequency-selective manner by using the speech recognition unit to make the suppression of speech by the ANC unit deliberately different than for other noises. The speech recognition unit performs a differentiation between speech and other noises for this purpose. This differentiation does not take place generally, but rather separately for each of the frequency ranges, thus in a frequency-dependent manner. The differentiation is then used to select and set a respectively optimal ANC strength for each of the frequency ranges. If no speech is contained in the noises from the surroundings, thus if speech is not recognized in any of the frequency ranges, the ANC unit then operates in a normal operation and in particular uniformly on all frequency ranges in this case and suppresses noises in a more or less broadband manner. The ANC strength is expediently set in this case in each frequency range depending on the amplitude of the noises.

In one advantageous embodiment, the hearing aid has an interference noise detector as part of the control unit, which interference noise detector measures or estimates an amplitude of interference noises in a respective frequency range. The respective ANC strength is then set depending on the amplitude of the interference noises. However, an interference noise detector is optional as such, alternatively, for example, a predefined ANC strength is simply set independently of interference noises. It is only when speech is present in one or more frequency ranges and this is also recognized, that normal operation is deviated from deliberately in these frequency ranges and the ANC strength is changed in the respective frequency range, namely changed relative to the ANC strength for this frequency range in normal operation. Although other noises are also present in a frequency range in addition to the speech, which are to be suppressed in principle, the speech is preferably given priority and the ANC strength is set depending on the presence of speech, even if this means that other noises which are present simultaneously to the speech in a frequency range are then not suppressed or are at least suppressed less strongly.

A respective frequency range is a partial range of an overall spectrum of frequencies which are recorded by the hearing aid, processed as needed, and output. The overall spectrum corresponds in particular to the audible range or a part thereof and extends between a lower limit and an upper limit, for example, 16 Hz to 20 Hz as the lower limit and 16 kHz to 20 kHz as the upper limit. The upper limit in particular is regularly lower for technical and/or physiological reasons, for example, at approximately 10 kHz. The frequency ranges preferably adjoin one another in pairs and do not overlap or only overlap slightly, for example, for technical reasons and by less than 10 Hz. The frequency ranges preferably cover the overall spectrum continuously. Except for a possible overlap as described, each frequency of the spectrum is preferably associated with only one single frequency range. The frequency ranges each have a width which can fundamentally be different for each frequency range. However, an embodiment is preferred in which all frequency ranges have the same width. Independently of this, a suitable width is 250 Hz in particular, other widths are also possible and suitable, however.

The term “frequency range” is sometimes also used as a simplified form to designate the “noises in a frequency range.”

Preferably, if speech is present in a respective frequency range, the ANC strength is set lower than in comparison to cases in which no speech is present in this frequency range, so that speech is suppressed less than other noises. Speech is thus deliberately excluded from the suppression by the ANC unit or at least suppressed less relatively considered than other noises. For example, the ANC strength for a first frequency range is 1 if no speech is present, the ANC strength is then set to a value less than 1, for example, to 0.5 or 0, if the speech recognition unit recognizes speech in this first frequency range. At the same time, the ANC strength in another, second frequency range is 0.9 if no speech is present, for example, since the noises are softer than in the first frequency range and thus require less suppression. If speech is then recognized in the first frequency range, but not in the second frequency range, the ANC strength of 0.9 is then retained in the second frequency range, so that noises are also optimally suppressed in this case. In the first frequency range, in contrast, the suppression is reduced to suppress the speech less. Overall, the speech comprehension is thus increased for the user, in that in the frequency ranges relevant at a given point in time, the noise suppression is reduced, and at the same time the maximum possible noise suppression takes place, namely in those frequency ranges which presently do not contain speech. Stated briefly: Speech is deliberately excluded from the noise suppression while at the same time other noises, especially interference noises, are suppressed as much as possible. In those frequency ranges in which speech has been recognized, a maximum noise suppression is dispensed with in favor of this speech.

Speech is generally differentiable into the user's own speech, i.e., speech of the user of the hearing aid, and external speech, i.e., speech of another person and in particular not of the user. Preferably, only external speech, which does not originate from the user of the hearing aid himself or herself, is recognized as speech by the speech recognition unit. In this way, external speech is deliberately excluded from the suppression by the ANC unit and the user's own speech is in particular still suppressed. This is based on the consideration that especially external speech is significant for the user, while the user's own speech does not necessarily have to be output with maximum comprehensibility. Thus if no external speech, but the user's own speech is present in a frequency range, the speech recognition unit accordingly recognizes that no speech is present. How specifically speech and especially external or the user's own speech is recognized, is initially not important in the present case. For example, speech is generally recognized by using an external microphone and especially the user's own speech is recognized by using an internal microphone in the auditory canal and the speech recognition unit then recognizes that external speech is present if speech in general is recognized, but not especially the user's own speech. The user's own and external speech can fundamentally also be recognized, like speech in general, on the basis of certain spatial, chronological, or spectral features, however.

In one expedient embodiment, the speech recognition unit has a Wiener filter, for recognizing speech, for each of the frequency ranges. Depending on how many frequency ranges are analyzed by the speech recognition unit, correspondingly many Wiener filters are present. A Wiener filter in particular has the advantage of a particularly rapid reaction time, which is, for example, a few milliseconds or less than 1 ms. A nearly instantaneous reaction to the presence of speech is thus possible and the ANC strength is deliberately adapted, preferably reduced, in a respective frequency range at those times at which speech is present in the respective frequency range. The Wiener filter is used in this context in particular as a stationarity detector, which indicates how rapidly a signal changes. This is based on the consideration that speech changes rapidly chronologically considered, while typical interference noises, for example, background noises, change less rapidly in comparison thereto and rather form a constant background. A misinterpretation possibly results in the case of nonstationary interference noises, for example, a bang or the like, and in the case of many simultaneous speakers in the background, for example, in a cocktail party situation. Nonetheless, the use of a Wiener filter results sufficiently often in adequate results. If speech is thus present, it is then typically nonstationary and is recognized by the Wiener filter, in contrast, for example, to a uniform noise which is stationary. In this way, particularly simple and particularly rapid speech recognition is implemented for each of the frequency ranges using a corresponding Wiener filter. In a more general embodiment, another stationarity detector instead of the Wiener filter is also advantageous.

The hearing aid preferably has a filter bank having multiple channels, each of which is associated with one of the frequency ranges. A filter bank is in particular an array of bandpass filters which each only permit a certain frequency component to pass of an incoming signal and output it as an outgoing signal. In the present case, in particular the input signal which is generated by the microphone is supplied to the filter bank, so that the input signal is divided onto the diverse channels and then each frequency range is processable individually. The filter bank accordingly generates a divided input signal from the input signal, which divided input signal is then supplied to the ANC unit and in particular also to the speech recognition unit, to be utilized, i.e., processed by these two in a frequency-selective manner in each case. The utilization of the individual channels in particular takes place in parallel to one another. The speech recognition unit and the ANC unit are also preferably operated in parallel to one another.

Each channel has a width which corresponds to the width of the corresponding frequency range, thus, for example, 250 Hz. The filter bank typically has more than 2 channels and regularly a plurality of channels, for example, between 10 and 100. In a suitable embodiment, the filter bank has 40 channels.

In the present case, it is not necessary that the ANC unit and the speech recognition unit utilize all channels of the filter bank, rather a subset is already sufficient. In other words: the number of the frequency ranges in which the speech recognition unit recognizes the presence of speech and for which the ANC strength is set depending on the presence of speech does not necessarily correspond to the number of the channels of the filter bank, but is less in a suitable embodiment. The hearing aid in principle accordingly processes a total number of frequency ranges, of which, however, not necessarily all are processed by the ANC unit and the speech recognition unit either. The ANC and the speech recognition for setting the ANC strength are thus restricted to a partial range of the overall spectrum, preferably to a lower part. In one preferred embodiment, the ANC unit is then configured to suppress noises only in those frequency ranges which lie below a limiting frequency. The limiting frequency is 1 kHz in a suitable embodiment. In the case of an exemplary filter bank having 40 channels and a respective width of 250 Hz, therefore only the bottom 4 channels are used in the ANC and the associated speech recognition. This is based on the observation that ANC is predominantly implementable technically sufficiently well for low frequency ranges than for high frequency ranges, so that ANC is expediently only carried out for low frequencies. Stationary interference noises are also regularly present in this case. At the same time, speech typically has high frequencies and is regularly not below 100 Hz or 200 Hz at low frequencies, so that then under certain circumstances and depending on dimensioning, those frequency ranges which are below this do not have any speech throughout and are processed with maximum ANC strength for optimum suppression of noises. In the range up to 1 kHz, however, regularly both speech and also interference noises are present, so that a differentiation is accordingly reasonable in this case, whereas above this ANC is expediently dispensed with and accordingly the problem of suppressed speech also does not occur at all.

In one suitable embodiment, the speech recognition unit outputs a discrete measure, i.e., a signal, for each of the frequency ranges for the presence of speech, so that the respective ANC strength is switched between only two values, the discrete measure is accordingly more or less “binary.” The discrete measure is, for example, a value of 0 or 1. The discrete measure is determined, for example, in that an absolute amplitude of the speech or an amplitude of the speech relative to an amplitude of interference noises is measured and is compared to a threshold value. The two values are, for example, “1,” also “on,” in particular if no speech is present, and “0,” also “off,” in particular if speech is present, the ANC unit is thus activated or deactivated in each frequency range depending on the presence of speech. Alternatively, the values “strong” and “weak” are suitable or numbers analogous thereto, especially if at least weak suppression of noises is still to take place even in the case of speech and the ANC unit is therefore not entirely deactivated.

As an alternative to the discrete measure, in an embodiment which is also suitable, the speech recognition unit outputs a continuous measure, i.e., a signal, for each of the frequency ranges for the presence of speech, so that the ANC strength is set continuously. The continuous measure is, for example, the absolute or relative amplitude, already described above, of speech in the respective frequency range or a value dependent thereon. A probability which specifies how probably speech is present in the respective frequency range is also suitable. For example, the speech recognition unit recognizes the presence of speech by using a classifier, which outputs the corresponding probability for a presence of speech for each frequency range. Alternatively, a discrete measure is derived from such a probability. In the case of a continuous measure, more than two values from a predefined operating range are then settable for the ANC strength, for example, the ANC strength is at least 0 and at most 1 and is set, for example, in gradations of 0.1.

The hearing aid preferably has a signal processing unit to amplify each of the frequency ranges using a settable amplification, in particular in parallel to the ANC unit. The signal processing unit in particular amplifies the input signal of the hearing aid and outputs it as an amplified signal. The amplification is either the same for all frequency ranges which are processed by the signal processing unit, or is frequency-dependent and is then different for various frequency ranges. A separate amplification is expediently settable for each of the frequency ranges. The signal processing unit and its settable amplification implement, in the intended use of the hearing aid, in particular its actual hearing aid functionality, namely a modification of the input signal depending on an individual hearing profile, also audiogram, of the user. In particular a hearing deficit of the user is thus compensated for in operation. This actual hearing aid functionality is independent in principle of the control described in this case of the ANC unit by using the speech recognition unit. The amplified signal of the signal processing unit and the feedback signal of the ANC unit are in particular output jointly through the receiver.

The amplification is preferably set in a frequency-dependent manner. In one suitable embodiment, in a respective frequency range, upon the presence of speech, the amplification is set greater in this case in this frequency range than in comparison to cases in which no speech is present, so that speech is amplified more than other noises. In other words: the amplification of the signal processing unit is set inversely to the ANC strength of the ANC unit, so that speech is amplified in particular using the signal processing unit. If speech is present, the amplification is increased and the ANC strength is reduced in the respective frequency range, and vice versa if no speech is present. The control of the signal processing unit and the setting of its amplification suitably take place analogously to the control of the ANC unit and the setting of the ANC strength, for example, by using the signal of the speech recognition unit. It is also possible in this case that the speech recognition unit recognizes speech in further frequency ranges in addition to the frequency ranges which are utilized by the ANC unit, so that a higher or at least different bandwidth is achieved for the control of the amplification.

Optionally, the ANC unit additionally has a feedback unit, which outputs a feedback signal for suppressing noises which are present inside the auditory canal, i.e., especially standing waves in the auditory canal due to an occlusion and noises caused by the user himself or herself, so-called intrinsic noises. However, the feedback unit and carrying out an AOR are not significant in the present case. The above statements on the feedforward unit and the feedforward signal also apply analogously to the feedback unit and its feedback signal.

With the objects of the invention in view, there is concomitantly provided a hearing aid which has a control unit configured to execute a method as described above. The control unit already described above is suitable for this purpose, so that suitable embodiments result from the above statements.

Other features which are considered as characteristic for the invention are set forth in the appended claims.

Although the invention is illustrated and described herein as embodied in a method for operating a hearing aid and a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, plan view of a hearing aid;

FIG. 2 is a schematic and block circuit diagram of the hearing aid of FIG. 1; and

FIG. 3 is a diagram showing an overall spectrum having multiple frequency ranges.

### DETAILED DESCRIPTION OF THE INVENTION

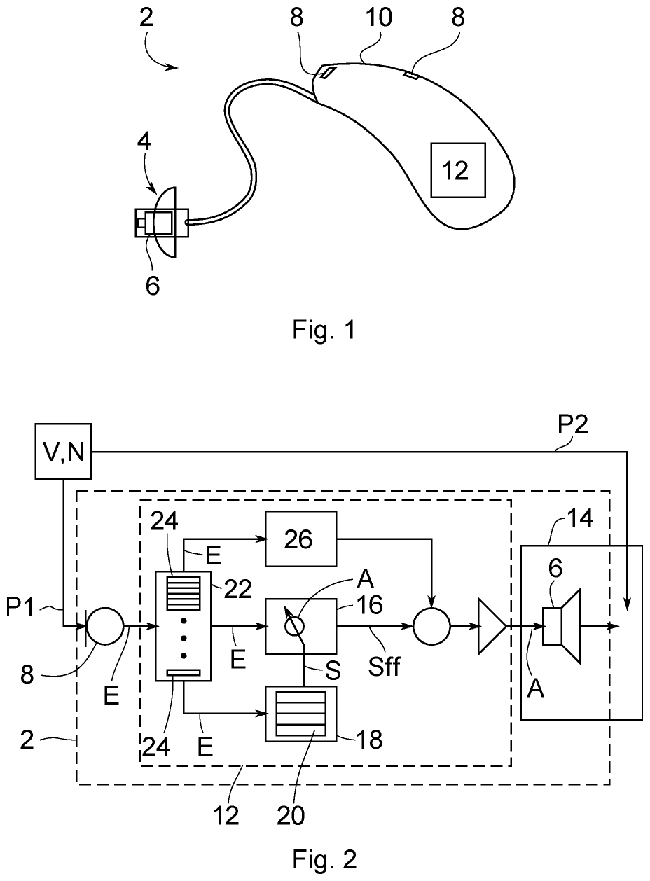

Referring now to the figures of the drawings in detail and first, particularly, to FIG. 1 thereof, there is seen a hearing aid 2, having an earpiece 4, a receiver 6, at least one external microphone 8, although two external microphones 8 are provided in this case by way of example, a housing 10, and a control unit 12. FIG. 2 shows the hearing aid 2 and its interconnection more precisely and in a different view, wherein only one of the two external microphones 8 is shown, however. In addition, FIG. 2 shows an auditory canal 14 of a user of the hearing aid 2 and two paths P1, P2, through which noises V, N from the surroundings can enter the auditory canal 14. Noises V, N enter the auditory canal 14 along the path P1, through the hearing aid 2, namely in that the noises V, N are recorded by using the microphone 8 and output through the receiver 6. Electrical processing takes place in the hearing aid 2 in this case. In contrast, along the path P2, noises V, N enter the auditory canal solely acoustically past the hearing aid 2 and especially past the earpiece 4. Electrical processing does not take place in this case. However, depending on the ambient conditions, for example, the shape of the ear or the seat of the earpiece and the like, a transmission function (not explicitly shown) results, by which the noises V, N are modified along the path P2.

During the intended use of the hearing aid, for example, as shown in FIG. 2, the user wears the hearing aid 2 in or on the ear. In the case of the hearing aid type shown herein, the user wears the housing 10 on the ear, more precisely behind the ear, and the earpiece 4 in the ear. The concepts described herein are also similarly applicable to other hearing aid types. A method for operating the hearing aid 2 is also described hereinafter on the basis of the figures, especially during the intended use of the hearing aid 2. The control unit 12 is configured in the present case to execute the method.

The hearing aid 2 is used in general to output noises to the user of the hearing aid 2 and especially in this case to compensate for a hearing deficit of the hearing-impaired user in this case. The hearing aid 2 has at least one microphone 8, which records the noises V, N from the surroundings, also referred to as ambient noises or ambient sound. The microphone 8 is a so-called external microphone 8 in this case, thus it faces outward with respect to the auditory canal 14 and in particular not into it. The microphone 8 converts the noises V, N into an input signal E, which is an electrical signal. The input signal E is processed by the control unit 12 of the hearing aid 2 as needed and finally supplied to the receiver 6, which converts the input signal E into sound, for output to the user.

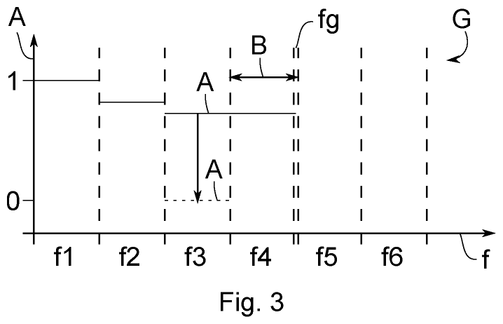

The hearing aid 2 has an ANC unit 16, wherein ANC is understood to mean active noise suppression, also referred to as “active noise cancellation.” The ANC unit 16 is a part of the control unit 12 in this case. The ANC unit 16 is configured, as shown in FIG. 3, to process multiple frequency ranges f1-f4 and at the same time to suppress noises V, N from the surroundings in each of these frequency ranges f1-f4 using a respectively settable ANC strength A. An example of the ANC strength A as a function of the frequency f is shown in FIG. 3. The ANC strength A is individually settable for each frequency range f1-f4. In FIG. 3, the ANC strength is greater in the frequency range f1 than in the frequency range f2 and is greater therein than in the frequency ranges f3, f4, in which the ANC strength A is equal.

The noises V, N from the surroundings regularly include, depending on the surrounding situation, interference noises N or useful noises or even both and regularly also speech V, which is typically a useful noise. The input signal E is supplied to the ANC unit 16 in the exemplary embodiment shown, either entirely or partially, but at least the frequency ranges f1-f4, which are then processed by the ANC unit 16. If still further frequency ranges f5, f6 are supplied, these are not necessarily processed, but are left unconsidered, for example. The ANC unit 16 analyzes the input signal E and outputs a feedforward signal Sff as a result thereof, for suppressing the noises V, N from the surroundings. Those noises V, N which penetrate during intended use from the outside and past the earpiece 4 into the auditory canal 14 are suppressed. The feedforward signal Sff is an electrical signal, which is supplied to the receiver 6 and is converted thereby into sound, which in turn entirely or partially extinguishes, i.e., suppresses, the noises V, N upon superposition in the auditory canal. Actual noise suppression takes place solely acoustically in this case and in particular not on an electrical level.

The ANC strength A specifies how strongly noises V, N are suppressed in the respective frequency range f1-f4. For example, the ANC strength A corresponds to an amplitude of the feedback signal Sff or an amplification factor, using which the feedback signal Sff is scaled in the ANC unit 16. The ANC strength A is accordingly a measure of the suppression of noises in the respective frequency range f1-f4. The greater the ANC strength A is, the stronger the suppression is. Vice versa, only minor suppression takes place at low ANC strength A. A complete deactivation of the ANC unit 16 for one or more frequency ranges f1-f4 is also possible, so that then no suppression of noises takes place in these ranges, the ANC strength A is then more or less “0.”

Furthermore, the hearing aid 2 has a speech recognition unit 18, for recognizing speech. The speech recognition unit 18 in the exemplary embodiment shown is a part of the control unit 12. The speech recognition unit 18 recognizes for each of the frequency ranges f1-f4 whether or not speech V is present therein. For this purpose, the input signal E is supplied to the speech recognition unit 18 in the present case, either entirely or partially, but at least the frequency ranges f1-f4, which are then processed by the speech recognition unit 18. If still further frequency ranges f5, f6 are supplied, these are not necessarily processed, but rather left unconsidered, for example. Alternatively or additionally, another input signal, which is generated, for example, by another, second microphone 8, is supplied to the speech recognition unit 18. In any case, the speech recognition unit 18 analyzes in the present case each of the frequency ranges f1-f4 separately, so that it is determined for each of these frequency ranges f1-f4 independently of the other frequency ranges f1-f4 whether or not speech V is present therein. The speech recognition unit 18 then outputs a signal S in the exemplary embodiment shown, which specifies for each of the frequency ranges f1-f4, whether or not speech V is present therein.

A core aspect in the present case is that the ANC unit 16 is controlled in such a way that the ANC strength A is set for a respective frequency range f1-f4 depending on whether or not the speech recognition unit 18 has recognized speech V in this frequency range f1-f4. In other words: the ANC unit 16 is controlled in a frequency-selective manner by using the speech recognition unit 18 to deliberately make the suppression of speech V by the ANC unit 16 different than for other noises N. In the exemplary embodiment shown, the setting of the ANC strength A by using the signal S is thus central and all other aspects are initially optional as such. The speech recognition unit 18 performs a differentiation between speech V and other noises, wherein this differentiation does not take place generally, but rather separately for each of the frequency ranges f1-f4, thus in a frequency-dependent manner. The differentiation is then used to select and set a respectively optimum ANC strength A for each of the frequency ranges f1-f4. If no speech V is contained in the noises from the surroundings, thus if speech V is not recognized in any of the frequency ranges f1-f4, the ANC unit 16 then operates in a normal operation and for this purpose uniformly on all frequency ranges f1-f4 and suppresses noises V, N in a more or less broadband manner, for example as illustrated in FIG. 3 by the sum of the horizontal solid lines in the frequency ranges f1-f4. The ANC strength A is set in this case, for example, in each frequency range f1-f4 depending on the amplitude of the noises V, N, so that sometimes different ANC strengths A result in normal operation in the various frequency ranges f1-f4, for example, as shown in FIG. 3.

In one advantageous embodiment (not explicitly shown), the hearing aid 2 has an interference noise detector as part of the control unit 12, which detector measures or estimates an amplitude of interference noises N, i.e., other noises N, in a respective frequency range f1-f4. The respective ANC strength A is then set depending on the amplitude of the interference noises N. Alternatively, for example, a predefined ANC strength A is simply set independently of interference noises N.

It is only when speech V is present in one or more frequency ranges f1-f4 and this is also recognized, that there is a deliberate deviation from the normal operation in these frequency ranges f1-f4 and the ANC strength A changes. For example, in FIG. 3, the speech recognition unit 18 has recognized speech V in the frequency range f3, whereupon the ANC strength A is reduced in this frequency range f3, for example, to the value shown in FIG. 3 by the horizontal, dashed line. The setting of the ANC strength A in reaction to the presence of speech V is also identified by using a vertical arrow in FIG. 3 for illustration. Even if still other noises N are present in a frequency range f1-f4 in addition to the speech V, which are in principle to be suppressed, the speech V is thus given priority in this case and the ANC strength A is set depending on the presence of speech V, even if this means that other noises N are then not suppressed or are at least suppressed less strongly.

A respective frequency range f1-f4 is a partial range of an overall spectrum G of frequencies, which are recorded by the hearing aid 2, processed as needed, and output. In FIG. 3, the first and lowermost six frequency ranges f1-f6 of an overall spectrum G (only partially shown) are shown by way of example. The overall spectrum G corresponds in this case to a part of the audible range and extends between a lower limit (not explicitly identified) and an upper limit (not explicitly shown), for example, 16 Hz to 20 Hz as the lower limit and 16 kHz to 20 kHz or less as the upper limit. In FIG. 3, the frequency ranges f1-f6 adjoin one another in pairs and do not overlap or only overlap slightly. In FIG. 3, the boundaries between two adjacent frequency ranges f1-f6 are indicated by a vertical dashed line, the boundary between the frequency ranges f4, f5 even by a double vertical dashed line. The frequency ranges f1-f6 each have a width B, which can be different in principle for each frequency range f1-f6. In the exemplary embodiment shown, however, all frequency ranges f1-f6 have the same width B, in the present case 250 Hz by way of example.

The term “frequency range f1-f6” is sometimes also used as a simplification to denote the “noises V, N in a frequency range f1-f6.”

In the exemplary embodiment shown, if speech V is present in a respective frequency range f1-f4, the ANC strength A is set lower than in comparison to cases in which no speech V is present in this frequency range f1-f4, so that speech V is suppressed less than other noises N. Speech V is thus deliberately excluded from the suppression by the ANC unit 16 or at least suppressed less considered relatively than other noises N. Overall, the speech comprehensibility is increased for the user, in that in the frequency ranges f1-f4 relevant at a given point in time, the noise suppression is reduced, and at the same time the maximum possible noise suppression takes place, namely in those frequency ranges f1-f4, which presently do not contain speech V.

Speech V is generally differentiable into the user's own speech, i.e., speech of the user of the hearing aid 2, and external speech, i.e., speech of another person and in particular not of the user. In the present case, only external speech, which does not originate from the user of the hearing aid 2 himself or herself, is recognized as speech V by the speech recognition unit 18. In this way, external speech is deliberately excluded from the suppression by the ANC unit 16 and the user's own speech is still suppressed. This is based on the consideration that especially external speech is important to the user, whereas the user's own speech does not necessarily have to be output with maximum comprehensibility.

In the exemplary embodiment shown, the speech recognition unit 18 has a Wiener filter 20 for each of the frequency ranges f1-f4, for recognizing speech V. Depending on how many frequency ranges f1-f6 are analyzed by the speech recognition unit 18, correspondingly many Wiener filters 20 are present, in FIG. 2 therefore four Wiener filters 20. A Wiener filter 20 has a reaction time which is, for example, a few milliseconds or less than 1 ms, so that a nearly instantaneous reaction to the presence of speech V is possible and the ANC strength A is deliberately reduced in a respective frequency range f1-f4 at those times at which speech V is present in the respective frequency range f1-f4. The Wiener filter 20 is used in this context as a stationarity detector, which indicates how quickly a signal changes. In a more general embodiment (not explicitly shown), another stationarity detector is used instead of the Wiener filter 20.

The hearing aid 2 shown additionally has a filter bank 22 having multiple channels 24, each of which is in each case associated with one of the frequency ranges f1-f6. The filter bank 22 is an array of bandpass filters, which each only let pass a certain frequency component, namely one of the frequency ranges f1-f6, of an incoming signal, the input signal E in this case, and output it as the outgoing signal. The sum of the outgoing signals of the channels 24 still corresponds to the input signal E, however. In the present case, the input signal E, which is generated by the microphone 8, is supplied to the filter bank 22, so that the input signal E is divided onto the diverse channels and then each frequency range f1-f6 is processable individually. The filter bank 22 accordingly generates a divided input signal E from the input signal E, which divided input signal is then supplied to the ANC unit 16 and also the speech recognition unit 18 in this case, to be utilized, i.e., processed by each of these two units in a frequency-selective manner. In principle, it is possible to supply the entire divided input signal E and then only to process a part thereof in the ANC unit 16 and the speech recognition unit 18, especially only the frequency ranges f1-f4 in this case. Equivalently thereto, only that part of the input signal E is already supplied which contains the relevant frequency ranges f1-f4 and the remaining frequency ranges f5, f6 are already separated off beforehand. In each case, the input signal E is respectively entirely or partially relayed to the ANC unit 16 and the speech recognition unit 18 from the filter bank 22. The utilization of the individual channels 24 in the ANC unit 16, on one hand, and the speech recognition unit 18, on the other hand, takes place in parallel to one another in this case, i.e., the speech recognition unit 18 and the ANC unit 16 are operated in parallel to one another in the exemplary embodiment shown.

Each channel 24 has a width which corresponds to the width B of the corresponding frequency range f1-f6, thus 250 Hz by way of example in this case. The filter bank 22 typically has more than 2 channels 24 and regularly a plurality of channels 24, for example, between 10 and 100. In the embodiment shown herein, the filter bank 22 has 40 channels 24.

As is already clear from the statements above, it is not necessary for the ANC unit 16 and the speech recognition unit 18 to utilize all channels 24 of the filter bank 22, rather a subset is already sufficient, the frequency ranges f1-f4 in this case. In other words: the number of the frequency ranges f1-f4, in which the speech recognition unit 18 recognizes the presence of speech V and for which the ANC strength A is set depending on the presence of speech V, does not necessarily correspond to the number of the channels 24 of the filter bank 22, but rather is sometimes less. The hearing aid 2 accordingly in principle processes a total number of frequency ranges f1-f6, of which not necessarily all are also processed by the ANC unit 16 and the speech recognition unit 18, however. The ANC and the speech recognition for setting the ANC strength A are therefore restricted to a partial range of the overall spectrum G, to a lower part in this case. In the exemplary embodiment shown, the ANC unit 16 is configured to suppress noises V, N only in those frequency ranges f1-f4 which are below a limiting frequency fg, which is illustrated in FIG. 3 by the vertical double dashed line already described. The limiting frequency fg is 1 kHz, for example. In the exemplary filter bank 22 having 40 channels 24 and a respective width B of 250 Hz, only the bottom 4 channels 24 are thus used in the ANC and the associated speech recognition. Both speech V and also interference noises N are regularly present in the range up to 1 kHz.

In one possible embodiment, the speech recognition unit 18 outputs a discrete measure S, i.e., signal S, for each of the frequency ranges f1-f4 for the presence of speech V, so that the respective ANC strength A is switched between only two values. The discrete measure S is, for example, a value of 0 or 1. As an alternative to the discrete measure S, in another embodiment, the speech recognition unit 18 outputs a continuous measure S, i.e., signal S, for each of the frequency ranges f1-f4 for the presence of speech V, so that the ANC strength A is set continuously. The continuous measure S is, for example, the absolute or relative amplitude of speech V in the respective frequency range f1-f4. A probability is also suitable which indicates how probably speech V is present in the respective frequency range f1-f4.

In addition, the hearing aid 2 shown herein has a signal processing unit 26 to amplify each of the frequency ranges f1-f6 using a settable amplification, in the present case in parallel to the ANC unit 16 and also in parallel to the speech recognition unit 18. The signal processing unit 26 amplifies the input signal E of the hearing aid 2 and outputs it as the amplified signal. The amplification is either the same for all frequency ranges f1-f6 which are processed by the signal processing unit 18, or frequency-dependent and then different for various frequency ranges f1-f4. The signal processing unit 26 and its settable amplification implement, during the intended use of the hearing aid 2, its actual hearing aid functionality, namely a modification of the input signal E depending on an individual hearing profile of the user, whereby a hearing deficit of the user is compensated for in operation. This actual hearing aid functionality is independent in principle of the control of the ANC unit 16 by using the speech recognition unit 18, however. The amplified signal of the signal processing unit 26 and the feedback signal Sff of the ANC unit 16 are output jointly through the receiver 6 in the present case.

In the present case, the amplification is also set in a frequency-dependent manner and for this purpose in a respective frequency range f1-f4 upon the presence of speech V. The amplification in this frequency range f1-f4 is set greater than in comparison to cases in which no speech V is present, so that speech V is amplified more than other noises N. In other words: the amplification of the signal processing unit 26 is set inversely to the ANC strength A of the ANC unit 16, so that speech V in particular is amplified using the signal processing unit 26. If speech V is present, the amplification is increased and the ANC strength A is reduced in the respective frequency range f1-f4, and vice versa if no speech V is present. The control of the signal processing unit 26 and the setting of its amplification take place, for example, analogously to the control of the ANC unit 16 and the setting of the ANC strength, for example, by using the signal S. However, this is not explicitly shown in FIG. 2.

The following is a summary list of reference numerals and the corresponding structure used in the above description of the invention:
2 hearing aid
4 earpiece
6 receiver
8 microphone
10 housing
12 control unit
14 auditory canal
16 ANC unit
18 speech recognition unit
20 Wiener filter
22 filter bank
24 channel
26 signal processing unit
A ANC strength
B width
E input signal
f frequency
f1, f2, f3, f4, f5, f6 frequency range
fg limiting frequency
G overall spectrum
N other noise, interference noise (noise in general)
P1 path
P2 path
S signal, measure (of the speech recognition unit)
Sff feedforward signal
V speech (noise in general)

1. A method for operating a hearing aid, the method comprising:
a) providing a hearing aid having an ANC unit and a speech recognition unit;
b) using the ANC unit to process multiple frequency ranges and to thereby suppress noises from the surroundings in each of the frequency ranges by using a respectively settable ANC strength;
c) using the speech recognition unit to recognize whether or not speech is present in each of the frequency ranges; and
d) controlling the ANC unit to set the ANC strength for a respective frequency range in dependence on whether or not the speech recognition unit has recognized speech in the respective frequency range.

2. The method according to claim 1, which further comprises upon a presence of speech in a respective frequency range, setting the ANC strength lower than when no speech is present in the respective frequency range, in order to suppress speech less than other noises.

3. The method according to claim 1, which further comprises recognizing only external speech not originating from a user of the hearing aid himself or herself as speech by the speech recognition unit.

4. The method according to claim 1, which further comprises providing the speech recognition unit with a Wiener filter for each of the frequency ranges, for recognizing speech.

5. The method according to claim 1, which further comprises providing the hearing aid with a filter bank having multiple channels each being associated with a respective one of the frequency ranges.

6. The method according to claim 1, which further comprises using the ANC unit to suppress noises only in frequency ranges below a limiting frequency.

7. The method according to claim 6, which further comprises selecting the limiting frequency as 1 kHz.

8. The method according to claim 1, which further comprises using the speech recognition unit to output a discrete measure for each of the frequency ranges for a presence of speech, causing the respective ANC strength to be switched between only two values.

9. The method according to claim 1, which further comprises using the speech recognition unit to output a continuous measure for each of the frequency ranges for a presence of speech, causing the ANC strength to be set continuously.

10. The method according to claim 1, which further comprises:
providing the hearing aid with a signal processing unit to amplify each of the frequency ranges using a settable amplification; and
setting the amplification higher in a respective frequency range upon a presence of speech than when no speech is present, causing speech to be amplified more than other noises.

11. A hearing aid, comprising a control unit configured to execute the method according to claim 1.
